(19) United States
(12) Patent Application Publication
(10) Pub. No.: US 2014/0321728 A1
(43) Pub. Date: Oct. 30, 2014

(54) METHODS FOR DETECTION AND CHARACTERIZATION OF IONIZING RADIATION EXPOSURE IN TISSUE

(71) Applicant: University of Massachusetts Medical School, Boston, MA (US)

(72) Inventor: Michael S. Chin, Worcester, MA (US)

(21) Appl. No.: 14/357,591

(22) PCT Filed: Nov. 28, 2012
(86) PCT No.: PCT/US12/66901

§ 371 Date: May 12, 2014

Related U.S. Application Data
(60) Provisional application No. 61/564,539, filed on Nov. 29, 2011.

(51) Int. Cl. G06T 7/00

(52) U.S. Cl. CPC G06T 7/0012
USPC 382/132

(57) ABSTRACT

The invention is based on the discovery of hyperspectral imaging-based methods that enable effective, efficient and non-invasive detection and characterization of ionizing radiation exposure in tissue. Methods of the invention allow for complete visualization and quantification of oxygenation and perfusion changes in irradiated skin. The invention enables rapid identification of individuals exposed to ionizing radiation after a radiological attack or accident. Methods of the invention can offer quantitative metrics to identify people exposed to higher doses of ionizing radiation well before the appearance of any dermal injury and permit appropriate triage to healthcare facilities.

### PRIORITY CLAIMS AND RELATED APPLICATIONS

This application is the U.S. national phase of and claims the benefit of priority from PCT/US12/66901, filed Nov. 28, 2012, which claims the benefit of priority from U.S. Provisional Application Ser. No. 61/564,539, filed Nov. 29, 2011, the entire content of each of which is incorporated herein by reference for all purposes.

### GOVERNMENT RIGHTS

This invention was made with Government support under grant no. NIH P30 DK32520 awarded by the NIH. The Government has certain rights in the invention.

### TECHNICAL FIELDS OF THE INVENTION

The invention generally relates to methods for detecting and analyzing ionizing radiation exposure in tissue. More particularly, the invention relates to methods for characterization of ionizing radiation exposure in tissue and the effect of ionizing radiation thereof using hyperspectral imaging-based techniques.

### BACKGROUND OF THE INVENTION

Ionizing radiation exposure can have profound biological consequences to skin and underlying subcutaneous tissue. Historically, concerns have focused on cutaneous injury secondary to radiotherapy, which can lead to skin damage, fibrosis, and wound healing complications. Other potential exposures include “dirty” bomb detonations and nuclear accidents, such as Chernobyl. (Chin, 2007 Singapore Med J48(10), 950-957; Barabanova, et al. 1990 Int J Radiat Biol 57(4), 775-782.) The recent events in the Fukushima Prefecture of Japan have highlighted the need for the development of non-invasive and rapid techniques to evaluate patients for potential ionizing radiation exposure. (Leelossy, et al. 2011J Environ Radioact 102(1), 1117-1121.) Radiological attacks or accidents often do not allow for appropriate implementation of dosimetry strategies, and current tests for determining total dose exposure in a post-hoc fashion require technical expertise and do not generate rapid results. (Christodouleas, et al. 2011 N Engl J Med 364(24), 2334-2341.)

Clinical use of ionizing radiation has become increasingly common with a majority of cancer patients receiving radiation therapy as a component of their treatment regimen. Ionizing radiation is known to induce a dose-dependent cascade of acute effects on the skin, collectively known as radiation dermatitis, which includes a progression of skin injury from erythema to more serious moist desquamation and ulceration. Long-term radiation-induced cutaneous complications include fibrosis, atrophy, induration, and secondary malignancy. (Olascoaga, et al. 2008 Int Wound J 5(2), 246-257.)

Detection of ionizing radiation exposure and/or injury by rapid and non-invasive means is currently unavailable. To date, various strategies that minimize time and invasiveness have been proposed to perform biodosimetry. Currently, the gold standard for detection of ionizing radiation exposure is chromosomal analysis. (Romm, et al. 2011 Radiation Research 175: 397-404.) Rapid throughput techniques have been developed that allow for automated processing of large sample sizes. (U.S. Pat. No. 7,822,249 B2 by Garty, et al.) However, this technique is limited by its necessity for venipuncture, need for a laboratory setting to process samples, and inability to provide point-of-care results for triage or treatment guidance.

Serum biomarkers present an opportunity to correct some of these shortcomings of chromosomal analysis by allowing for potential point-of-care testing without the need for a laboratory setting. (Chaudhry 2008 J Biomed Sci 15: 557-563.) Despite numerous potential targets being identified, there are no validated serum biomarkers in clinical use at present time that provide sensitive and specific assessments of ionizing radiation exposure and biodosimetry. (Menard, et al. 2006 Cancer Res 66:1844-1850; Guipaud, et al. 2007 Proteomics 7:3992-4002; Ossetrova, et al. 2009 Int J Radiat Biol 85: 837-850; Britten, et al. Health Phys 98: 196-203; Lee, et al. 2007 Mt J Radiation Oncology Biol Phys 69: 1273-1281; Kabacik, et al. 2011 Int J Radiat Biol 87: 115-129; U.S. Patent Publ. No. 2009/0318556 A1 by Idle, et al.; U.S. Patent Publ. No. 2009/0289182 A1 by Pevsner; U.S. Pat. No. 6,025,336 B2 by Goltry, et al.) In addition, serum biomarkers still require venipuncture and are thus not non-invasive.

Characterization of irradiated normal tissue, namely the skin, is currently limited. Past studies have been unable to simultaneously investigate changes in perfusion and oxygenation as separate parameters. Particularly regarding changes in oxygenation and perfusion of the skin, laser Doppler flowmetry (LDF) and transcutaneous tissue oximetry techniques are the major methods used for assessing changes in oxygenation and perfusion. (Aitasalo, et al. 1986 Plast Reconstr Surg 77:256-267; Thanik, et al. 2011 Plast Reconstr Surg 127:560-568; Amols, et al. 1988 Radiology 169:557-560; Rudolph, et al. 1994 Cancer 74:3063-3070.) Devices and designs exist for probes that utilize these technologies. (U.S. Patent Publ. No. 2008/0015449 A1 by Kaylie; U.S. Pat. No. 5,654,539 by Borgos, et al; U.S. Pat. No. 6,178,342 B1 by Borgos, et al.; U.S. Pat. No. 4,290,431 by Herbert, et al.; U.S. Pat. No. 4,296,752 by Welsh, et al.; U.S. Pat. No. 4,407,291 by Hagihara, et al.; U.S. Patent Publ. No. US 2010/0130842 A1 by Hayoz, et al.) However, it should be noted that there are significant limitations to both strategies, and neither has the capacity to simultaneously measure both oxygenation and perfusion levels in tissue.

Laser Doppler flowmetry has several distinct disadvantages. It relies on unobstructed reflection of the laser signal and therefore is unreliable in most hair-bearing areas. Additionally, the laser Doppler probes used clinically measure only a small area (1 mm² in some instances) and thus are highly prone to sampling error. While wide-field devices utilizing laser Doppler flowmetry are being developed, these methods continue to utilize flow velocity as a surrogate for tissue perfusion and remain unable to assess tissue oxygenation. (Rajan, et al. 2009 Lasers Med Sci 24: 269-283; U.S. Patent Publ. No. US 2009/0118623 A1 by Serov, et al.; U.S. Pat. No. 7,496,395 B2 by Serov, et al.)

Transcutaneous oxygenation probes used clinically sample an area of 5 mm² and may not be representative of the oxygenation of the entire tissue sample especially in areas of ischemia where perfusion may change drastically over small distances. As a result of their small sampling area, these probes too are susceptible to sampling bias. In addition, they require the need to heat the skin for accurate sampling and thus have the potential to cause discomfort and delay in obtaining data. They have not gained widespread adoptance in the clinical arena for characterizing oxygenation changes in skin. (Lima, et al. 2005 Intensive Care Med 31:1316-1326.)

Thus, current methods all required some aspect of invasiveness, whether it be venipuncture or tissue harvest. Techniques relying upon serum biomarkers or chromosome analysis are not as rapid (i.e., a minimum of minutes to hours). Specific to serum markers, there are significant concerns about its specificity and sensitivity as it has not been validated to the degree that tests are clinically available.

Therefore, an urgent need continue to exist for effective, efficient, non-invasive methods for detection and characterization of ionizing radiation exposure in tissue.

### SUMMARY OF THE INVENTION

The invention is based on the discovery of hyperspectral imaging-based methods that enable effective, efficient and non-invasive detection and characterization of ionizing radiation exposure in tissue. Methods of the invention allow for complete visualization and quantification of oxygenation and perfusion changes in irradiated skin. The invention enables rapid identification of individuals exposed to ionizing radiation after a radiological attack or accident. Methods of the invention can offer quantitative metrics to identify people exposed to higher doses of ionizing radiation well before the appearance of any dermal injury and permit appropriate triage to healthcare facilities.

In one aspect, the invention generally relates to a method for detecting a subject's exposure to ionizing radiation. The method includes: obtaining photographic imagery of one or more areas of superficial tissue of the subject at one or more wavelengths and one or more time points; and characterizing the obtained photographic imagery to measure one or more physiological properties in the one or more areas of superficial tissue to detect the level of ionizing radiation exposure of the subject.

In another aspect, the invention generally relates to a method for determining the time elapse from a prior ionizing radiation exposure of a subject. The method includes: obtaining photographic imagery of one or more areas of superficial tissue of the subject at one or more wavelengths and one or more time points; and characterizing the obtained photographic imagery to measure one or more physiological properties in the one or more areas of superficial tissue to determine the time elapsed from a prior ionizing radiation exposure of the subject.

In yet another aspect, the invention generally relates to a method for determining the degree of ionizing radiation exposure by a subject. The method includes: obtaining photographic imagery of one or more areas of superficial tissue of the subject at one or more wavelengths and one or more time points; and characterizing the obtained photographic imagery to measure one or more physiological properties in the one or more areas of superficial tissue to determining the degree of ionizing radiation exposure of the subject.

In yet another aspect, the invention generally relates to a method for monitoring the dosage and location of radiation treatment in human medical therapy. The method includes: obtaining photographic imagery of one or more areas of superficial tissue, at one or more wavelengths and one or more time points, of a subject receiving radiation treatment; and quantitatively characterizing oxygenation and perfusion changes in the one or more areas of superficial tissue to determine the dosage and location of radiation received by the subject.

### BRIEF DESCRIPTION OF THE DRAWINGS

FIG. 1. Mean scores (arbitrary units) as a function of time after a localized 50-Gy dose of beta-irradiation to the skin.

FIG. 2. Visible (VIS), hyperspectral selective (HSI), oxyhemoglobin selective (HT-OXY) and deoxyhemoglobin selective (HT-DEOXY) windows on select days following irradiation for a representative subject. 1 cm×1 cm areas are reproduced 100% to scale. A dual axis scale for interpretation of the HSI window is provided (a). For HT-OXY and HT-DEOXY windows, a single axis scale is provided (b).

FIG. 3. Mean oxygen saturation (a), total hemoglobin (b), HT-Oxy (c), and HT-Deoxy (d) as a function of time after irradiation. Error bars are displayed representing ±standard deviation. Dashed lines represent baseline values in each plot respectively.

FIG. 4. Representative photomicrographs of sections stained with picrosirius red and visualized under polarized light from irradiated (a) and non-irradiated (b) skin. Bar graph (c) demonstrating a significantly higher (p<0.001) red/green ratio in irradiated versus non-irradiated skin. Errors bars represent +SEM.

FIG. 5. Mean oxygen saturation (a) and total hemoglobin (b) in irradiated skin as a function of time after irradiation. Error bars represent ±SEM. Dashed lines represent baseline values in each plot, respectively.

FIG. 6. Mean oxygen saturation (a) and total hemoglobin (b) in non-irradiated skin as a function of time after irradiation. Error bars represent ±SEM. Dashed lines represent baseline values in each plot, respectively.

FIG. 7. Photomicrographs of sections stained for CD31 from irradiated (a) and non-irradiated (b) areas for a representative subject. Bar graph (c) demonstrating a significant reduction (p<0.001) in blood vessel density in irradiated versus non-irradiated skin. Errors bars represent +SEM.

FIG. 8. Photomicrographs of sections stained for pimonidazole to assess for epidermal hypoxia (arrowheads indicating hypoxic cells) from irradiated (a) and non-irradiated (b) areas for a representative subject. Bar graph (c) demonstrating no significant difference in epidermal hypoxia between irradiated and non-irradiated skin. Errors bars represent +SEM.

FIG. 9. Bar graphs demonstrating target gene expression in irradiated (gray) and non-irradiated (black) cutaneous tissue (a). RT-qPCR was performed on RNA isolated from irradiated and non-irradiated tissue samples harvested on Day 56 post-irradiation. To determine relative changes in target gene mRNA levels, results were normalized to expression of the reference gene UBC. Non-irradiated skin was normalized to 1. Error bars represent +SEM. * indicates p<0.05 and ** indicates p<0.01. Immuno-stained sections qualitatively demonstrated upregulation of VEGF protein expression in irradiated (b) fields versus non-irradiated (c).

FIG. 10. Human breast perfusion over first 30 days of irradiation.

FIG. 11. HSI patient breast image.

### DETAILED DESCRIPTION OF THE INVENTION

The invention is based on the discovery of hyperspectral imaging-based methods that enable effective, efficient and non-invasive detection and characterization of ionizing radiation exposure in tissue. Methods of the invention do not rely on serum biomarkers or chromosomal analysis. For example, changes in the oxy- and deoxy-hemoglobin levels as assessed by their reflectance and absorbance of visible light in areas of irradiated skin to predict ionizing radiation exposure and subsequent injury. The methods are fast and non-invasive. In addition, results are available at the point-of-care and allow for immediate triage and decision-making ability. The invention allows for rapid (e.g., seconds) acquisition of data and should allow for data processing in a similar time-frame. With regards to the ability of hyperspectral imaging to characterize changes in perfusion and oxygenation in normal tissue, the invention allows for the simultaneous assessment of oxygenation and perfusion changes.

During the past two decades, radiation therapy has become increasingly common and raises concerns over associated radiation complications including fibrosis, ulceration, infection and poor wound healing. This clinical scenario is often challenging for the reconstructive surgeon. (Blondeel, et al. 2009 Plast Reconstr Surg 124: 28-38.) Therefore, the ability to accurately assess the extent and degree of chronic radiation injury becomes paramount not only for wound surveillance, but also in reconstructive surgical planning There are currently no reliable methods for in vivo evaluation of irradiated tissue, and this is in part due to a poor understanding of the complex pathophysiology. (Ryan 2012 J Invest Dermatol 132: 985-993; Yarnold, et al. 2010 Radiother Oncol 97: 149-161.)

One of the most widely accepted mechanisms of cutaneous radiation injury centers on the role of tissue ischemia. Many early histological studies demonstrated chronic hypovascularity of irradiated soft tissue. (Marx 1987 Schweiz Monatsschr Zahnmed 97: 1081-1086; Marx, et al. 1990 Am J Surg 160: 519-524; Sumi, et al. 1984 Plast Reconstr Surg 74: 385-392.) However, while once a generally accepted hypothesis, this idea has been challenged. Using transcutaneous oxygen monitoring, Rudolph et al. has demonstrated that irradiated skin is not actually hypoxic, and instead proposed that chronic fibrosis is secondary to a dysfunction of myofibroblasts. (Rudolph, et al. 1994 Cancer 74: 3063-3070.) Other studies have supported these findings demonstrating that there is no evidence for chronically hypoxic tissue. (Aitasalo, et al. 1986 Plast Reconstr Surg 77: 256-267.) The fundamental question is whether it is possible to have hypovascular tissue that has normal oxygenation. The major limitation of previous studies is that none were able to simultaneously measure perfusion and tissue oxygenation, which if achievable would have numerous clinical and research advantages. (Dougherty, et al. 1992 J Med Eng Technol 16: 123-128.) In addition, previous studies which utilized transcutaneous oxygen monitoring or laser Doppler flowmetry were highly susceptible to sampling error due to small probe size. (Lima, et al. 2005 Intensive Care Med 31: 1316-1326.)

Hyperspectral imaging (HSI) is a type of wide-field diffuse reflectance spectroscopy technology that has recently found various applications in the biomedical field, including assessments of diabetic foot ulcers and peripheral vascular disease. (Khaodhiar, et al. 2007 Diabetes Care 30(4), 903-910; Chin, et al. 2011J Vasc Surg, Epub pub. online Jul. 29, 2011.) Additionally, HSI has been used in murine and porcine models to study cutaneous perfusion during mechanical stress and hemorrhagic shock, respectively. (Chin, et al. 2010 Tissue Eng Part C Methods 16(3), 397-405; Cancio, et al. 2006 J Trauma 60(5), 1087-1095.) HSI is a method of wide-field diffuse reflectance spectroscopy that utilizes a spectral separator to vary the wavelength of light entering a digital camera and provides a diffuse reflectance spectrum for every pixel. These spectra are then compared to standard transmission solutions to calculate the concentration of oxyhemoglobin (HT-Oxy) and deoxyhemoglobin (HT-Deoxy) in each pixel, from which spatial maps of tissue oxygenation are constructed as previously described by Yudovsky et al. (Yudovsky, et al. 2010 J Diabetes Sci Technol 4(5), 1099-1113.) OxyVu-2 (HyperMed Inc.) is a commercially available device that generates tissue oxygenation maps of the sub-papillary plexus. This modality provides simultaneous measurements of cutaneous tissue oxygenation and perfusion that is both non-invasive and reproducible.

HSI may allow for rapid and effective evaluation of acute cutaneous injury following irradiation. The aim of the current study is to examine the ability of HSI to assess cutaneous changes in oxygenation and perfusion during the acute period following irradiation. The invention provides hyperspectral imaging-based techniques for the detection of ionizing radiation exposure in normal tissue. More specifically, the invention utilizes changes in the spectral signature of skin, including those representative oxy- and deoxy-hemoglobin levels, to assess ionizing radiation exposure and predict the development of acute and chronic skin injury. The normal tissues that have been studied include skin and subcutaneous tissue. Hyperspectral allows for simultaneous measurements of oxygenation and perfusion over a wide-field. In addition to oxyhemoglobin and de-oxyhemoglobin, the reflectance wavelength patterns of collagen, lipids, water content, beta-carotene, and melanin have been previously established, and therefore these chromophores may also be readily utilized to analyze changes in irradiated tissue. (Andersen, et al. 1990 Photodermatol Photoimmunol Photomed. 7(6):249-57; Nachabe, et al. 2011J Biomed Opt. 16(8):087010; Yudovsky, et al. 2010 Appl Opt. 49(10):1707-19.) The spectral signature is represented by selected specific wavelengths of visible and infrared light, ranging 350-1600 nm. The aspects of normal tissue are the skin and any external surface of the body (e.g., eyes, nails, hair, etc.).

In one aspect, the invention generally relates to a method for detecting a subject's exposure to ionizing radiation. The method includes: obtaining photographic imagery of one or more areas of superficial tissue of the subject at one or more wavelengths and one or more time points; and characterizing the obtained photographic imagery to measure one or more physiological properties in the one or more areas of superficial tissue to detect the level of radiation exposure of the subject.

In another aspect, the invention generally relates to a method for determining the time elapse from a prior ionizing radiation exposure of a subject. The method includes: obtaining photographic imagery of one or more areas of superficial tissue of the subject at one or more wavelengths and one or more time points; and characterizing the obtained photographic imagery to measure one or more physiological properties in the one or more areas of superficial tissue to determine the time elapsed from a prior ionizing radiation exposure of the subject.

In yet another aspect, the invention generally relates to a method for determining the degree of ionizing radiation exposure by a subject. The method includes: obtaining photographic imagery of one or more areas of superficial tissue of the subject at one or more wavelengths and one or more time points; and characterizing the obtained photographic imagery to measure one or more physiological properties in the one or more areas of superficial tissue to determining the degree of ionizing radiation exposure of the subject.

In yet another aspect, the invention generally relates to a method for monitoring the dosage and location of radiation treatment in human medical therapy. The method includes: obtaining photographic imagery of one or more areas of superficial tissue, at one or more wavelengths and one or more time points, of a subject receiving radiation treatment; and quantitatively characterizing oxygenation and perfusion changes in the one or more areas of superficial tissue to determine the dosage and location of radiation received by the subject.

In certain embodiments, the photographic imagery is obtained from one area of superficial tissue of the subject. In certain other embodiments, the photographic imagery is obtained from two or more (e.g., 2, 3, 4, 5) areas of superficial tissue of the subject.

Characterization of the obtained photographic imagery to measure one or more physiological properties may include the measurement of the level of one or more of oxygenated hemoglobin, de-oxygenated hemoglobin, collagen, lipids, water content, beta-carotene, and melanin. In some embodiments, this involves the quantification of the level of oxygenated hemoglobin in the imaged area of the subject, the level of de-oxygenated hemoglobin in the imaged area of the subject, an increase or decrease in measured levels of oxygenated hemoglobin in the imaged area of the subject is used as an indication of exposure to ionizing radiation, an increase or decrease in measured levels of oxygen saturation in the imaged area of the subject is used as an indication of exposure to ionizing radiation, and/or an increase or decrease in measured levels of perfusion in the imaged area of the subject is used as an indication of exposure to ionizing radiation.

The photographic imagery is obtained at one wavelength or at two or more wavelengths, and detection wavelength may be selected from the range from about 350 nm to about 1,600 nm

In certain embodiments, characterization of the obtained photographic imagery to measure one or more physiological properties includes comparing imagery obtained from the specific subject to reference data from a normal population of subjects not exposed to ionizing radiation.

The methods may be applied to a human subject or an animal.

The subject may have been exposed to ionizing radiation as a diagnostic or therapeutic tool in the course of medical treatment and/or is suspected of having been exposed to ionizing radiation as a result of nuclear medical therapy, nuclear accident, nuclear materials handling, nuclear terrorism, or a nuclear weapon detonation.

Methods disclosed herein allows detection of changes to determine what tissue has been exposed to irradiation well in advance of any visible and/or clinical signs of ionizing radiation injury to the skin or external normal tissues, including erythema, edema, pigmentation changes, desquamation, or any other visible irregularities. In terms of the scope of earlier assessment using this technique, one can reliably detect ionizing radiation exposure about 24-48 hours following a dose of 50 Gy of ionizing radiation. Using visible assessment, this is at least a 50% reduction in time to detection.

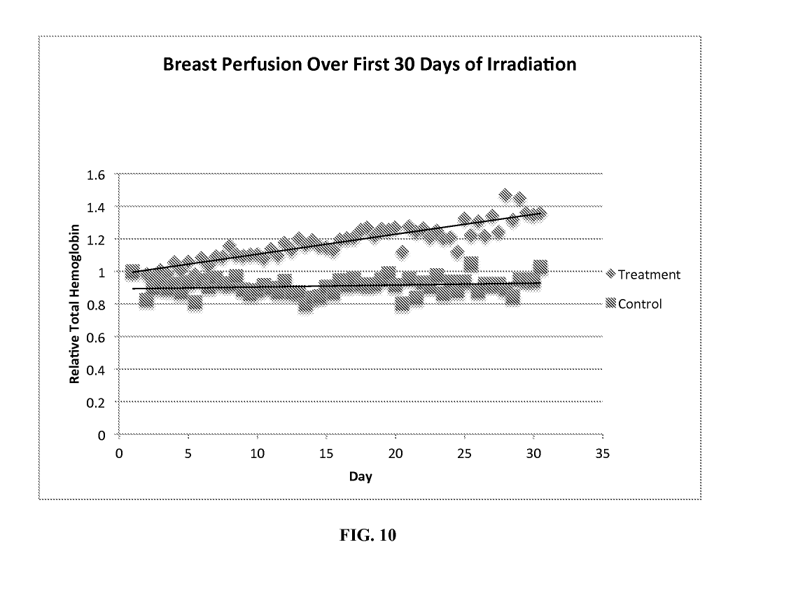

The disclosed method allows quantitative determination of radiation dose utilizing a mathematical algorithm and a referenced linear relationship between de-oxy and oxy hemoglobin values and radiation dose intensity. The disclosed method also allows monitoring radiation dosage for radiation therapy treatment utilizing a mathematical algorithm and a referenced linear relationship between total hemoglobin and number of days of treatment (FIG. 10).

Methods of the invention are applicable in various fields. First, the invention may be applied to detection and characterization of normal tissue changes following radiotherapy, including assuring accurate radiotherapy dosing, predicting adverse normal tissue reactions before they become clinically apparent, guiding treatment to lessen adverse normal tissue effects, assessing the radiosensivitiy of the normal tissue of individuals as this is known to be variable based on individual host factors, characterizing the spectral signature of tissue acutely injured by radiation exposure to predict chronic complications (e.g. fibrosis, atrophy, contracture, necrosis, ulceration, infection, secondary malignancy), characterizing acute tissue injury following radiotherapy and/or exposure to radioactive materials, and characterizing chronic tissue injury following radiotherapy and/or exposure to radioactive materials.

Second, detection of ionizing radiation exposure in various contexts such as following a radiological attack or accident. Information obtained by methods disclosed herein can be used to assist in medical triage of those potentially exposed to ionizing radiation following a radiological attack, nuclear accident, or other form of radioactive material exposure, surveillance of individuals known or unknown to have come in contact with radioactive materials, performing selective population screening of normal tissue to assess for distant ionizing radiation exposure (e.g. determine distant ionizing radiation exposure from materials involved in nuclear weapon or power development), performing acute, sub-acute and/or chronic surveillance of normal tissue effects in populations (human or animal) in areas that are known or have the potential to be contaminated with radioactive materials.

In addition, methods of the invention may be applied to detection of ionizing radiation sensitivity, and potential acute and chronic effects, in patients who have received ionizing radiation exposure during diagnostic radiological procedures including conventional plain film radiography, mammography, fluoroscopy, angiography, and CT scan.

### EXAMPLES

### Animals

This study was performed in accordance with Institutional Animal Care and Use Committee guidelines. Ten 8-week old male SKH1-E hairless mice (Charles River Laboratories, Wilmington, Mass.) were used to facilitate ease of optical imaging. (Schaffer, et al. 2010 Mol Cancer Ther 9(8), 2354-2364.) This strain of hairless mice is immunocompetent and amelanotic. Tattoo marks were placed with a 26-gauge needle circumferentially around the area of the flank to be irradiated to allow for precise sequential scanning of the same area. Animals were irradiated on Day 0 and sacrificed on Day 56, eight weeks later. Most translational models use time points beyond 4 weeks as representative of chronic radiation injury. (Thanik, et al. 2011 Plast Reconstr Surg 127: 560-568; Flanders, et al. 2002 Am J Pathol 160: 1057-1068.) Specimens from irradiated as well as non-irradiated flank skin (to serve as internal control) were harvested at time of sacrifice.

Irradiation

Irradiation protocol and dosimetry was based on a previously published model. (Coggle, et al. 1984 Radiat Res 99(2), 336-345.) Mice were placed longitudinally in the lateral decubitus position on the base of a standard burette stand. The bottom end of an acrylic tube was positioned flush against the skin of the flank and secured to the stand with a standard burette clamp. A guide was placed at the top of the acrylic tube to ensure exact positioning of the source on the flank within the tube. Mice were exposed to a beta-radiation dose using a 13-mm diameter strontium-90 source (Amersham International). The active diameter of the source was 9-mm, with areas beyond this receiving no ionizing radiation. The target dose was 50-Gy at a depth of 95-μm in the skin with less than 10% of the total dose penetrating beyond 3 mm. This procedure was repeated to create bilateral flank wounds for a total of 20 wounds on 10 mice.

### Example 1

### Hyperspectral Imaging

Spatial maps of tissue oxygenation were generated using a commercially available HSI system (OxyVu-2, HyperMed). The general optical properties of this device have been previously described. (Yudovsky, et al. 2011 J Biophotonics 4(7-8), 565-576.) A narrow band-pass liquid crystal tunable filter (LCTF-10-20, CRI Inc.) was used to vary the wavelength of light passed on to a digital imaging detector (Guppy F-146B, Allied Vision Technologies) to provide many images at 15 select wavelengths between 500- and 660-nm. Broadband light emitting diodes were used to illuminate the sample (Luxeon, Philips LumiLed Inc.). Twenty-second scans of tissue samples were obtained at a 12-inch focal distance. Data was analyzed online using a fiducial target to achieve spectral decomposition and two-dimensional image registration techniques. (Yudovsky, et al. 2010 J Diabetes Sci Technol 4(5), 1099-1113.) Diffuse reflectance tissue spectra were determined for each pixel within this collection of images using proprietary algorithms. Mean HT-Oxy and HT-Deoxy values were obtained from a 79-pixel diameter region of the images of the irradiated area by decomposition using standard spectra for HT-Oxy and HT-Deoxy. False color images were created to demonstrate tissue oxygenation spatially. The spatial resolution of the HT-Oxy and HT-Deoxy images was 60-microns. Perfusion was measured as total hemoglobin (tHb) which was calculated as the sum of HT-Oxy and HT-Deoxy. Tissue oxygenation (StO₂) was calculated as HT-Oxy divided by tHb. HT-Oxy, HT-Deoxy and tHb are reported as arbitrary values that have previously been shown to correlate well with respective in vivo molar concentrations. (Yudovsky, et al. 2010 J Diabetes Sci Technol 4(5), 1099-1113.)

Prior to imaging, the system was calibrated to a reference card (CheckPad, HyperMed Inc.) for all acquisitions and pixel reflectance was determined relative to this standard reflectance. A fiducial target was used to correct for motion artifact from respiratory effort. The mice were then placed in the lateral decubitus position on black background that was positioned over a heated 38° C. blanket (T/Pump, Gaymar). Mice were anesthetized with a ketamine/xylazine mixture for image acquisition. Wounds were left untreated for image acquisition.

Imaging was obtained immediately before irradiation on day 0, within 2 hours following irradiation, and then on days 1, 2, 3, 4, 7, 9, 11, 14, 16, 18, and 21. Image processing was conducted following image acquisition. Tattoo marks placed prior to irradiation were visible in the generated tissue oxygenation maps and allowed for serial tissue oxygenation measurements of the irradiated area to be made using the OxyVu-2 user interface. Similar serial measurements were also performed on flank skin outside the irradiated field to serve as an internal control.

Skin Assessment

Skin reaction assessment was made by two independent, blinded observers using visible images captured by the OxyVu-2 system at the same time that HSI images were obtained. The method used to score the skin's acute reaction to external irradiation is based on a scale used by Randall and Coggle, with a score of 0 representing normal skin, 1 representing erythema, 2 representing dry desquamation and/or pigmentation changes, 3 representing incomplete moist desquamation, and 4 representing complete moist desquamation. (Randall, et al. 1995 Int J Radiat Biol 68(3), 301-309.)

Statistical Methods

Plots of oxygenation and perfusion data are expressed as the mean±standard deviation. Differences in outcomes between time points were evaluated using general mixed linear models given repeated measures were made. (McLean, et al. 1991 The American Statistician 45(1), 54-64.) In the presence of significant time effects, pairwise comparisons were made using Fisher's LSD multiple comparisons procedure without multiplicity adjustments. (Winer 1971 Statistical principles in experimental design, McGraw-Hill Book Company, New York.) Compliance with the distributional assumption of normality was evaluated using the Kolmogorov-Smirnov one sample goodness of fit test for normality applied to model residuals. Calculations were performed using the Proc Mixed procedure of the SAS statistical Software package (SAS Institute Inc.). Statistical significance was assumed when p was less than 0.05.

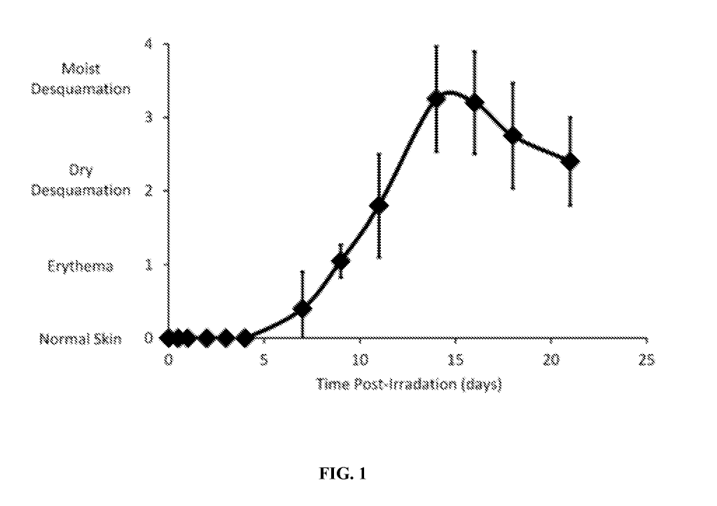

There was 100% response in all irradiated areas (n=20). Seventeen areas developed moist desquamation, and three resulted in dry desquamation. No systematic difference in HSI signal was observed between areas of dry and moist desquamation Skin reactions were first visible on day 7, with peak formation on day 14, and resolution beginning by day 21. Mean skin scores are displayed in FIG. 1.

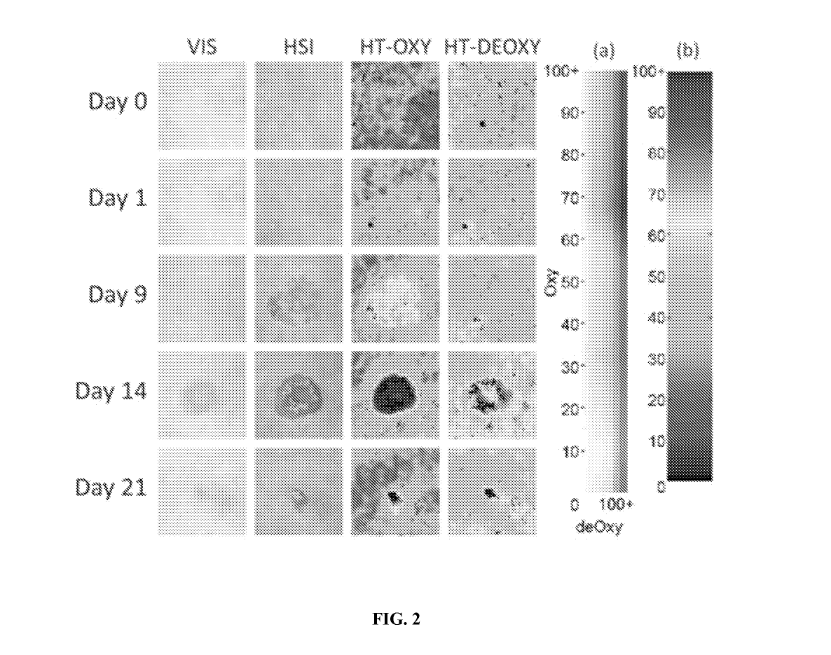

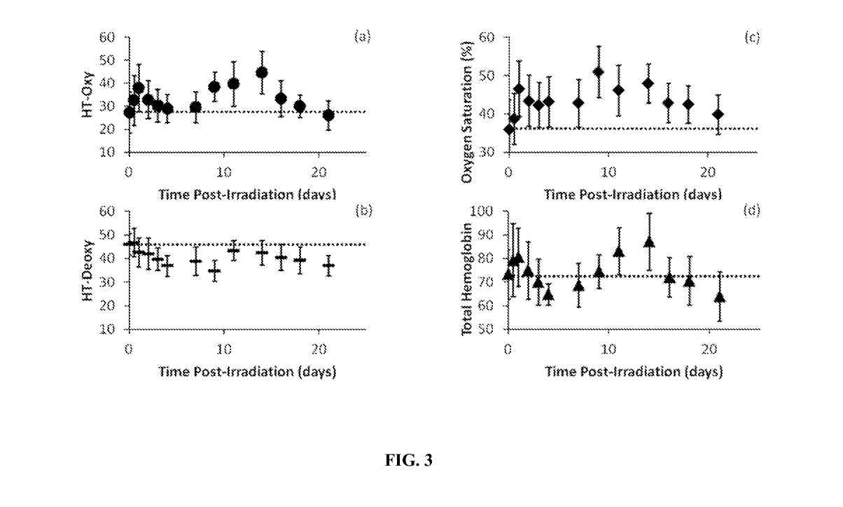

Spatial maps of tissue oxygenation demonstrated changes following ionizing radiation exposure (FIG. 2). These spatial maps were analyzed to yield mean HT-Oxy and HT-Deoxy levels over time (FIGS. 3a and 3b). From these values, mean tissue oxygen saturation and total hemoglobin levels were derived (FIGS. 3c and 3d). Compared to pre-irradiation day 0 values, tissue oxygen saturation was significantly increased over baseline by day 1 (p<0.001). Tissue oxygen saturation remained elevated above baseline through day 21 (p<0.05 for all times except 2 h post-irradiation). Post-irradiation changes demonstrated two relative peaks of tissue oxygen saturation over surrounding days. Tissue oxygen saturation on day 1 was increased by 30% over baseline, after which there was a plateau with oxygen saturation values consistently 20% above baseline until day 7. A second and more prominent peak in oxygen saturation occurred at day 9 where oxygenation levels increased 42% relative to baseline. Following this second peak, there was a gradual return to near baseline by day 21. In areas of non-irradiated flank skin, no significant changes in mean tissue oxygen saturation were detected over the 21 days of observation (data not shown).

When compared to the pre-irradiation day 0 values, mean total hemoglobin was significantly increased over baseline by day 1 (p<0.02). Post-irradiation trends were similar to those for tissue oxygen saturation beginning with a peak at 10% above baseline by day 1. Total hemoglobin levels also increased a second time starting on day 9 and were 20% above baseline on day 14 (p<0.001). Interestingly, not only did tHb levels begin to decrease back to baseline after the second peak in a pattern similar to tissue oxygen saturation, but also dropped below baseline levels by day 21 (p<0.002). In areas of non-irradiated flank skin, no significant changes in mean tHb levels were detected over the 21 days of observation (data not shown).

Prevailing theories suggest the etiology may be the result of direct cellular injury, cellular signaling pathway dysregulation, or ischemia. (Rudolph, et al. 1994 Cancer 74(11), 3063-3070; Martin, et al. 2000 Int J Radiat Oncol Biol Phys 47(2), 277-290; Marx, et al. 1990 Am J Surg 160(5), 519-524.) The literature examining whether radiation-induced skin damage is primarily mediated by vascular effects has generally focused on perfusion changes beyond 12 months. Studies examining acute perfusion changes (<1 month) are limited.

The most direct measurement of tissue oxygenation is by tonometry. Aitasalo and Aro describe early post-irradiation (days 1 and 35) hypoxia in the subcutaneous tissue of a rabbit hind limb utilizing surgically implanted tissue tonometers to directly measure tissue oxygen tension. (Aitasalo, et al. 1986 Plast Reconstr Surg 77(2), 256-267.) In the acute period, it was found that oxygen tension was decreased. Less invasive strategies have employed transcutaneous oxygen sensors for the same purpose and demonstrated that irradiated skin maintains normal tissue oxygenation in patients at least one year after irradiation. (Rudolph, et al. 1994 Cancer 74(11), 3063-3070.) However, this technique is limited by its measurement of a small area and requirement to heat the skin for accurate diffusion of oxygen across the skin.

LDF has been proposed as an alternative to non-invasive monitoring of perfusion, but has yielded inconsistent results. Utilizing LDF, there has been evidence of acute rise in cutaneous blood flow after doses of at least 20-Gy, and findings that perfusion was not decreased 1-year after radiation for breast cancer. (Amols, et al. 1988 Radiology 169(2), 557-560; Benediktsson, et al. 1999 Br J Plast Surg 52(5), 360-364.) However, LDF has also demonstrated that within six months of radiation, microvasculature has a reduced response to a heat stress. (Doll, et al. 1999 Radiother Oncol 51(1), 67-70.) Qualitative LDF imaging has also been used to show a decrease in cutaneous perfusion for 6-weeks following irradiation. (Thanik, et al. 2011 Plast Reconstr Surg 127(2), 560-568.) The main disadvantage to LDF is that blood flow velocity is being used as a surrogate marker for perfusion. While this hypothesis often holds true for normal physiology, pathologic processes that may distort tissue architecture can alter the implied relationship between flow and perfusion. (Azizi, et al. 2011 Acta Ophthalmol pub. online Sep. 28, 2011.)

From the above studies, it was evident that there are inconsistencies among these findings. There are two common factors that confound these studies: sampling bias and time to measurement. Both transcutaneous and LDF rely primarily on point probes for measurement. Such a method is prone to sampling bias as perfusion can differ greatly from site to site even within the same irradiated field. Timing of measurement is also critical since it is evident from the observations that both increases and decreases in oxygenation and perfusion can be seen in the acute period depending on the stage of skin reaction. Furthermore, a clear distinction must be made between measurement of tissue oxygenation versus perfusion as the two physiologies are related, but not identical.

In the present study, HSI were used effectively to demonstrate changes in irradiated skin. Unlike previous methods, HSI is not prone to sampling error and is able to reliably generate a complete map of tissue oxygenation over a relatively large area. In addition, HSI measures the HT-Oxy and HT-Deoxy content of the sub-papillary plexus itself and thus provides simultaneous measurement of total hemoglobin and tissue oxygen saturation. As a result, it is not reliant on a single surrogate marker to make conclusions regarding tissue oxygenation and perfusion.

Our results support previous studies demonstrating an early rise in perfusion within the first few weeks. (Amols, et al. 1988 Radiology 169(2), 557-560; Nystrom, et al. 2004 Skin Res Technol 10(4), 242-250.) However, none of these studies examined the patterns of perfusion change within this acute period. The ability of the OxyVu-2 system to quantify HT-Oxy and HT-Deoxy levels permits simultaneous analysis of changes in tissue oxygen saturation and total hemoglobin content over time in the acute post-irradiation phase. The increase in both of these parameters within the first day suggests that local metabolic processes may be increasing local tissue oxygen demand in this very early phase of radiation injury. HT-Oxy levels appear responsible for these observed increases. Near the end of week one post-irradiation, total hemoglobin declined to below baseline levels despite tissue oxygen saturation remaining above pre-irradiation levels. This appears driven by declining HT-Deoxy levels and suggests local venous constriction, edema or decreased oxygen exchange may be occurring.

At the second peak near two weeks post-irradiation, oxygen saturation and total hemoglobin levels similar to the first peak were observed and indicated a possible change in local metabolic conditions that may be distinct from the very early process. Unlike the first peak, both HT-Oxy and HT-Deoxy increased proportionally suggesting an overall increase in blood volume. Following this second peak, a gradual decline in oxygenation levels and a more pronounced decrease in perfusion were observed, which may be the result of decreasing HT-Oxy values since HT-Deoxy values only modestly decline, suggesting decreased arterial inflow.

### Example 2

### Hyperspectral Imaging

Spatial maps of tissue perfusion and oxygenation were generated using a commercially available HSI system (OxyVu-2, HyperMed Inc., Greenwich, Conn.). The general optical properties of this device have already been described. (Yudovsky, et al. 2011 J Biophotonics 4: 565-576.) A liquid crystal tunable filter (LCTF-10-20, CRI Inc., Hopkinton, Mass.) was used to vary the wavelength of light passed onto a charge-coupled device (Guppy F-146B, Allied Vision Technologies, Stadtroda, Germany) to provide many images at select wavelengths between 500- and 660-nm. Light emitting diodes were used to illuminate the sample (LUXEON, Philips Lumiled Inc., San Jose, Calif.). Twenty-second scans of tissue samples were obtained at a 17-inch focal distance. Data was analyzed in real-time using a fiducial target to achieve spectral decomposition and two-dimensional image registration techniques. (Yudovsky, et al. 2010 J Diabetes Sci Technol 4: 1099-1113.) Diffuse reflectance tissue spectra were determined for each pixel within this collection of images using proprietary algorithms. Mean oxy-hemoglobin (Hb-Oxy) and deoxy-hemoglobin (Hb-Deoxy) values were obtained from a 79-pixel diameter region of the images corresponding to the irradiated area by decomposition using standard spectra for Hb-Oxy and Hb-Deoxy. False color image maps were constructed to demonstrate Hb-Oxy and Hb-Deoxy levels spatially. The spatial resolution of the Hb-Oxy and Hb-Deoxy images was 60 μm.

Perfusion was measured as total hemoglobin (tHb) which was calculated as the sum of Hb-Oxy and Hb-Deoxy. Tissue oxygenation (StO₂) was calculated as Hb-Oxy divided by tHb. Hb-Oxy, Hb-Deoxy and tHb are reported as arbitrary values that have previously been shown to correlate well with respective in vivo molar concentrations. (Yudovsky, et al. 2010 J Diabetes Sci Technol 4: 1099-1113.)

Prior to imaging, the system was calibrated to a reference card (CheckPad, HyperMed Inc.) and pixel reflectance was determined relative to this standard. Mice were placed in the lateral decubitus position on black background positioned over a heating blanket (T/Pump®, Gaymar Industries Inc., Orchard Park, N.Y.). Mice were anesthetized with a ketamine/xylazine mixture for image acquisition.

A baseline scan was obtained immediately before irradiation on Day 0 and then repeated on Days 7, 14, 28, and 56. Image processing was conducted following image acquisition. Tattoo marks placed prior to irradiation were visible in the generated tissue perfusion and oxygenation maps, which allowed for serial measurements of these parameters to be made in the irradiated area using the OxyVu-2 user interface. Similar serial measurements were also performed on flank skin outside the irradiated field to serve as an internal control.

Immunohistochemistry

To assess for CD31 and VEGF expression, immunostaining was performed as previously described. (Chin, et al. 2010 Tissue Eng Part C Methods 16: 397-405.) Briefly, paraffin-embedded sections were rehydrated, and sections for CD31 were treated with 40 μg/ml Proteinase K (Roche Diagnostic Corp., Indianapolis, Ind.) solution in 0.2M Tris-H₂O for 20 minutes at 37° C. Antigen retrieval for vascular endothelial growth factor (VEGF) was accomplished by microwaving in 10 mM sodium citrate (pH 6.0). Anti-mouse primary antibodies for CD31 (1:100, cat. 553370, Pharmingen, San Jose, Calif.) and VEGF (1:200, AR-493-NA, R&D Systems, USA) were incubated overnight at 4° C. Signals were amplified in association with Tyramide Amplification System® (PerkinElmer, Boston, Mass.) using biotinylated mouse anti-rat IgG(H+L) (1:200, BA-4001, Vector Laboratories, Burlingame, Calif.) for CD31 and horse anti goat IgG (1:200, BA-9500) for VEGF. Activation was performed with DAB Chromogen (Dako North America Inc., Carpinteria, Calif.). Slides were counterstained with hematoxylin (Hematoxylin 2, Richard-Allan Scientific, Kalamazoo, Mich.).

Pimonidazole hydrochloride staining was used to mark hypoxic epidermal cells. The marker (70 mg/kg) had been injected intraperitoneally 30-60 minutes prior to sacrifice and marks cells with pO₂ less than 10 mmHg. Paraffin-embedded sections were rehydrated and then treated with 20 ml of diluted BD Retrievagen A (Pharmigen) in a microwave for 20 minutes and blocked with 10% goat serum for 1 hour and incubated with Hypoxyprobe™-1 monoclonal antibody (Hypoxyprobe™-1 Kit, NPI, Burlington, Mass.) for 1 hour. After washing, the sections were incubated with secondary antibodies in peroxidase labeled rabbit anti-rat IgG (Dako Inc., Carpinteria, Calif.). Substrate reaction was performed using Liquid DAB+Substrate Chromagen System (Dako Inc.) for 10 minutes followed by DAB Enhancer (Dako Inc.) for 5 minutes. Sections were then counterstained using Harris hematoxylin (Leica Microsystems, Richmond, Ill.).

Digital images were obtained from the middle of all stained skin sections. Vessel number (CD31) was quantified using 3 random fields at 10× magnification. Quantification of hypoxic cells (pimonidazole) was performed using 3 fields at 40× magnification. Positively stained cells in the epidermis were counted. Vessel and hypoxic cell counts for each animal were expressed as a ratio between the irradiated sample and its respective internal control. VEGF stained sections were photographed at 10× and irradiated samples were qualitatively compared to controls.

Picrosirius Red Staining

Picrosirius red staining was used to analyze collagen composition. Paraffin-embedded sections were de-waxed and re-hydrated. Nuclei were stained with Harris hematoxylin for 8 minutes, and the slides were then washed for 10 minutes in running tap water. Staining was then performed with 0.1% Picrosirius Direct Red 80 (Sigma-Aldrich, St. Louis, Mo.) for 1 hour.

Analysis of birefringent collagen was performed as previously described. (Cuttle, et al. 2005 Wound Repair Regen 13: 198-204.) To visualize the birefringence, the microscope (BX-41, Olympus America Inc., Center Valley, Pa.) was equipped with a simple polarizing setup (U-ANT and U-POL, Olympus America Inc.) that was adjusted until the background was black and the stained collagen fibers displayed as bright red and green. Sections were photographed (Evolution MP 5.0, Media Cybernectics, Bethesda, Md.) under polarized light at 20× magnification using the RGB color model. Quantification was performed separately for papillary and reticular dermis by image morphometry as analyzed by ImageJ (National Institutes of Health, Bethesda, Md.) using a color pixel counter to quantify the pixel area of red (type I collagen-like) and green (type III collagen-like) in each section. The ratios red to green were then calculated for each field (by dividing the area for red by the area for green), and the average and standard deviation of the mean were calculated for each treatment.

RNA Isolation and cDNA Synthesis

Total RNA was isolated from both irradiated and non-irradiated harvested skin that was preserved in RNAlater (Qiagen, Valencia, Calif.) using PureZOL RNA Isolation Reagent (Bio-Rad Laboratories Inc., Hercules, Calif.). Genomic DNA contamination was removed using DNase I digestion (Bio-Rad). Reverse transcription was performed using the iScript Advanced cDNA kit (Bio-Rad) according to the manufacturer's instructions using 8μ15×iScript reaction mix, 2 μl iScript reverse transcriptase, 10 μl H₂O and 5 μl RNA template. The purity and concentration of the resulting DNA was assessed with a NanoDrop 2000 (Thermo Fisher Scientific Inc., Wilmington, Del.).

Quantitative Polymerase Chain Reaction (qPCR) Analysis

Primers for target genes (VEGF, VEGFR-1, and VEGFR-2) and the selected reference gene Ubiquitin C (UBC) were designed using NCBI Primer-BLAST (http://www.ncbi.nlm.nih.gov/tools/primer-blast/). The primers were tested for specificity using UCSC In-Silico PCR (http://exon.ucsc.edu/cgi-bin/hgPcr). Primer sequences are listed in Table 1. Primer specificity was confirmed by melt curve analysis. UBC was selected as the most suitable reference gene following preliminary analysis of 6 candidate reference genes. (data not shown)

TABLE 1
Primer Sequences

| Gene | | |
|---|---|---|
| Symbol | Gene Name | Primer Sequences |
| UBC | Ubiquitin C | F: TGTGGGATGGCATCA |
| | | ACATTTGTCA |
| | | R: TGATGGTTTTTCGGG |
| | | GTGGGGG |
| VEGF | Vascular endothelial | F: ACTTGTGTTGGGAG |
| | growth factor | GAGGATGTC |
| | | R: AATGGGTTTGTCGT |
| | | GTTTCTGG |
| VEGFR-1 | Vascular endothelial | F: GAGGAGGATGAGGG |
| | growth factor | TGTCTATAGGT |
| | receptor 1 | R: GTGATCAGCTCCAG |
| | | GTTTGACTT |
| VEGFR-2 | Vascular endothelial | F: GCCCTGCCTGTGGT |
| | growth factor | CTCACTAC |
| | receptor 2 | R: CAAAGCATTGCCCA |
| | | TTCGAT |

^{a} - All primer sequences are given in 5′ → 3′ direction

The expression analysis was performed using a 96-well plate (Hard-Shell® 96-Well PCR Plate, Bio-Rad) on a CFX-96 Touch Real-Time PCR Detection System (Bio-Rad) with the SsoAdvanced SYBR Green Supermix (Bio-Rad). Reactions were performed according to the manufacturer's instructions. Briefly, samples were amplified in 20 μl reactions containing 20 ng cDNA, 10 μl SYBR Green Supermix and 500 pmol each of the forward and reverse primers. Cycling conditions were as follows: 95° C. for 30 s, followed by 40 cycles of 5 s at 95° C. and 30 s at 60° C. Melt curve analysis was performed immediately following qPCR over a range of 65-95° C. All samples were run in triplicate, with all genes run on one plate for each sample to avoid between-run variation. No-template control wells were included for all runs. For qPCR data analysis, the previously described AACₜ method was applied. (Livak, et al. 2001 Methods 25: 402-408.) Non-irradiated flank skin harvested concurrently with irradiated tissue was normalized to 1 for analysis.

Statistical Methods

For hyperspectral data, plots of oxygenation and perfusion data are expressed as the mean±standard error of the mean (SEM). Differences in outcomes between time points were evaluated using general mixed linear models given repeated measures. (McLean, et al. 1991 The American Statistician 45: 54-64.) Pairwise comparisons were made using Fisher's least significant difference multiple-comparisons procedure if the model was significant. (Winer, B. J. 1971 Statistical Principles in Experimental Design. New York: McGraw-Hill.) Compliance with the distributional assumption of normality was evaluated using the Kolmogorov-Smirnov one-sample, goodness of fit test for normality applied to model residuals. Calculations were performed using the Proc Mixed procedure of the SAS® Statistical Software package (SAS Institute, Inc. Cary, N.C.). Statistical significance was assumed when p was less than 0.05.

For immunohistochemical and picrosirius red stained samples, two-tailed unpaired t-tests were performed with the assumption of equal variance. Statistical significance was assumed when p was less than 0.05.

Formation of Chronic Fibrosis

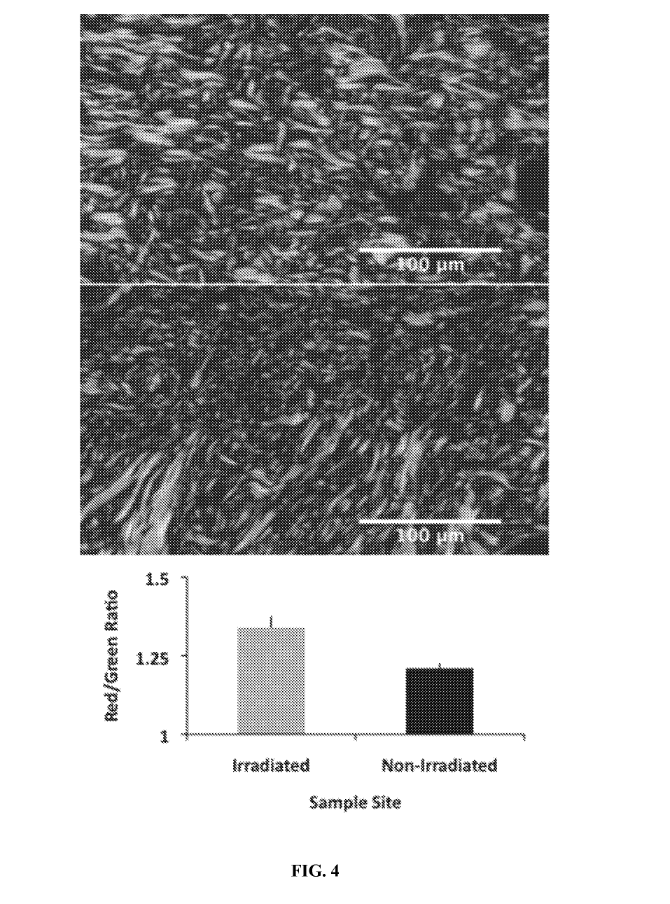

All irradiated sites (n=20) developed erythema by Day 7 and moist desquamation by Day 14 post-irradiation. By Day 28, there was complete resolution of the wound, and the epithelium had developed a waxy appearance consistent with fibrosis. Picrosirius red stained sections of the papillary dermis verified an increased red/green ratio consistent with fibrosis when compared to unwounded skin (mean±SEM: 1.34±0.008 vs. 1.21±0.005, p<0.001) as seen in FIG. 4. Analysis of the reticular dermis demonstrated no significant difference in red/green ratio.

Perfusion and Oxygenation Changes

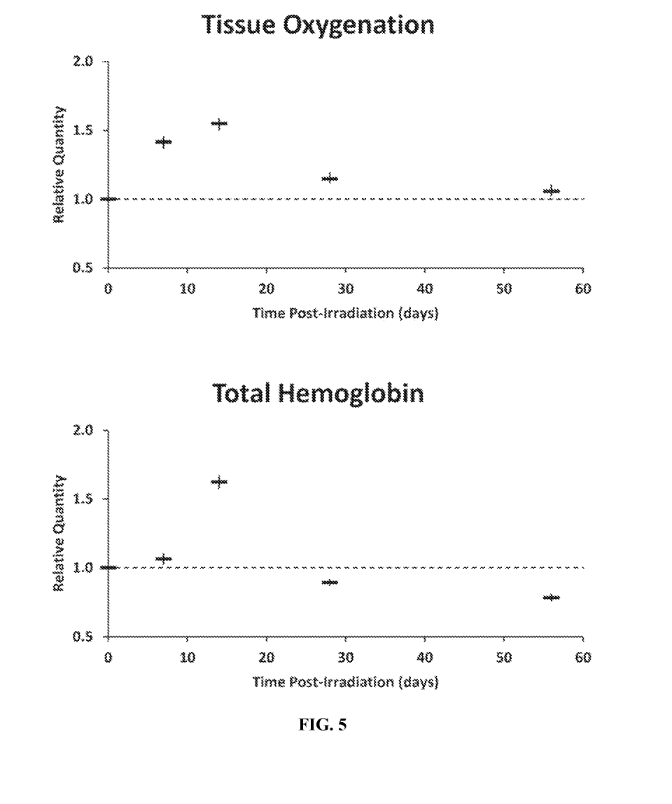

Spatial maps of tissue oxygenation demonstrated changes following irradiation. These spatial maps were analyzed to yield mean Hb-Oxy and Hb-Deoxy levels. From these values, mean StO₂ and tHb levels were derived for the 8-week period following irradiation. (FIG. 5)

Compared to pre-irradiation Day 0 values, a peak in tHb was seen at Day 14 coinciding with the appearance of moist desquamation. At the time of wound resolution on Day 28, tHb began declining with a noted significant 21% decrease from baseline by Day 56 (p<0.001). For StO₂, there was a similar peak at Day 14, but a noted steady return to baseline StO₂ by Day 28 that remained unchanged through Day 56.

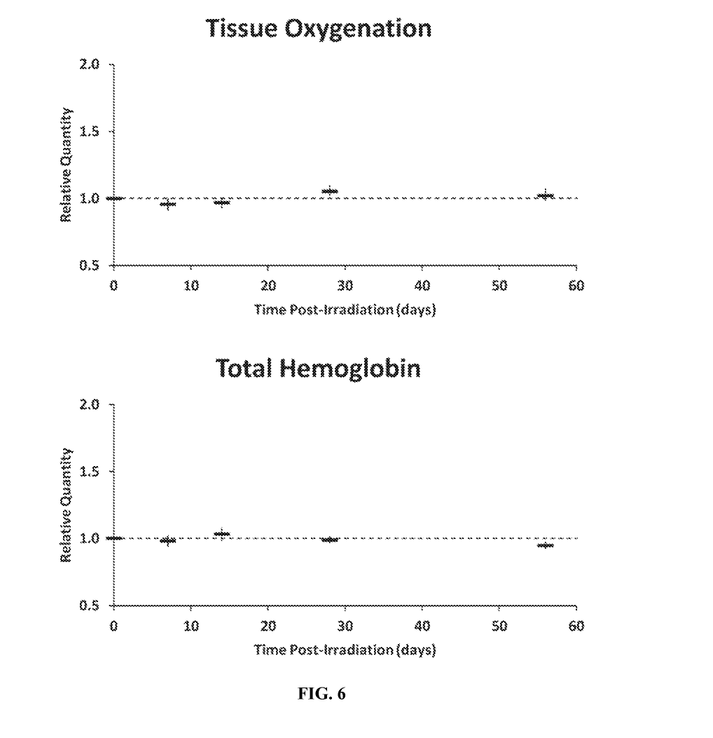

Consistent to findings in a previous study concerning StO₂ and tHb in irradiated tissue during the acute phase, significant changes in these parameters were not identified in non-irradiated internal control flank skin. (FIG. 6) (Chin, et al. 2012 J Biomed Opt 17: 026010.)

Vascular Changes and Hypoxic Cell Fraction

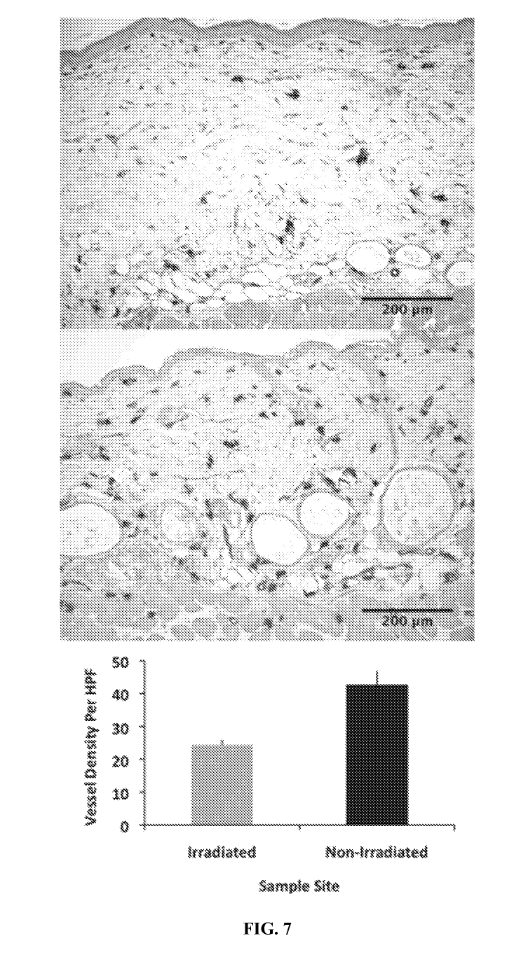

CD31 stained sections of irradiated skin harvested on Day 56 demonstrated a significant 43% reduction in vessel density when compared to internal controls (p<0.001). (FIG. 7)

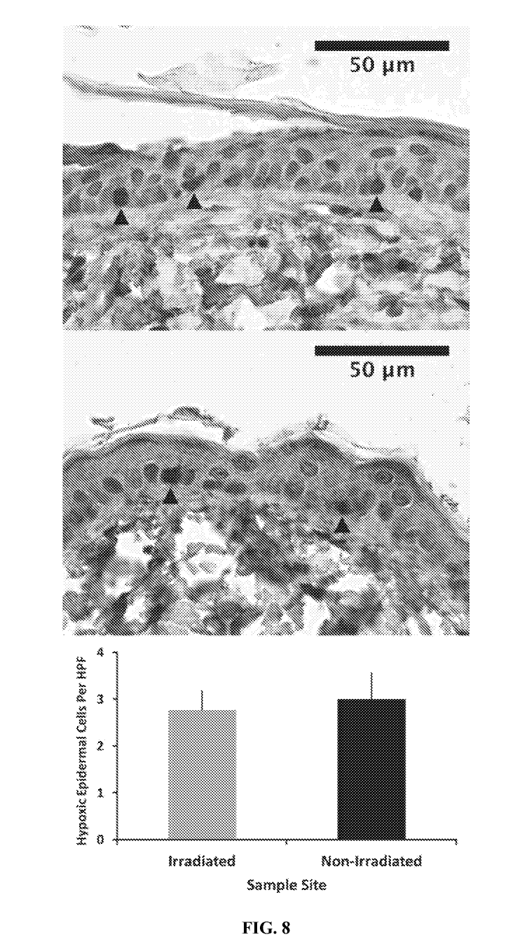

Pimonidazole stained sections of irradiated skin on Day 56 did not demonstrate significantly different hypoxic epidermal cell fraction when compared to internal controls (mean±SEM: 2.77±0.42 vs. 3.00±0.57, p=0.57). (FIG. 8)

VEGF and Associated Receptor Expression

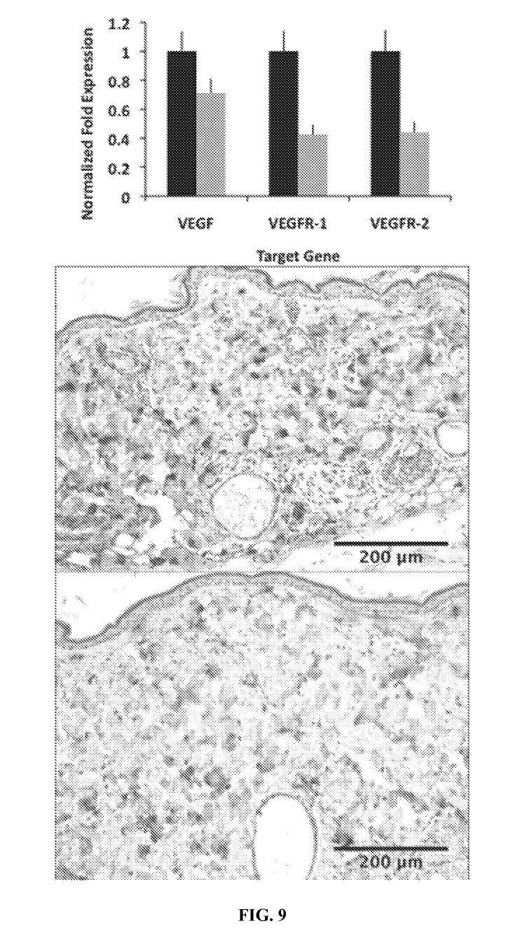

Gene expression analysis using RT-qPCR demonstrated significant 29% decrease in VEGF expression in irradiated skin samples on Day 56 when compared to internal control skin. (FIG. 9a) Associated 57% and 56% decreases were also seen in VEGFR-1 and VEGFR-2 expression, respectively. (FIG. 8a) Verifying gene transcription, immunohistochemical stains for VEGF protein demonstrated qualitatively lower VEGF expression in irradiated samples. (FIGS. 9b and 9c)

A murine model of radiation fibrosis was successfully developed that could be verified histologically. Under polarized light microscopy, it was noted an increased red/green collagen ratio in irradiated skin. Birefringence analysis associates color with collagen type: red with type 1 collagen-like and green with type 3 collagen-like. (Flanders, et al. 2002 Am J Pathol 160: 1057-1068; Cuttle, et al. 2005 Wound Repair Regen 13: 198-204.) Increased red/green ratio was evident in the papillary dermis and consistent with previous studies demonstrating an increased collagen type 1 to type 3 ratio of the upper dermis in radiation fibrosis. (Flanders, et al. 2002 Am J Pathol 160: 1057-1068; Sultan, et al. 2011 Plast Reconstr Surg 128: 363-372; Riekki, et al. 2002 Arch Dermatol Res 294: 178-184.)

Imaging this model with HSI, changes in oxy-hemoglobin and deoxy-hemoglobin were quantified as distinct entities over a large area. From these values, total hemoglobin and tissue oxygen saturation were derived. Total hemoglobin was used as a representative marker of perfusion; tissue oxygen saturation was used as an indirect surrogate of tissue oxygenation. Although not a direct measure of tissue oxygenation, tissue oxygen saturation measures the subtle oxygenation changes in the microcirculation of sub-dermal papillary plexus reflecting local tissue oxygen delivery and extraction. These changes have been used previously as an indirect indicator of tissue oxygenation. (Chin, et al. 2010 Tissue Eng Part C Methods 16: 397-405; Cancio, et al. 2006 J Trauma 60: 1087-1095; Greenman, et al. 2005 Lancet 366: 1711-1717; Jafari-Saraf, et al. 2012 Ann Vasc Surg 26: 537-548; Harrison, et al. 1992 Clin Phys Physiol Meas 13: 349-363; Hanna, et al. 1997 Br J Surg 84: 520-523; Hanna, et al. Br J Surg 82: 1352-1356.) Using this analysis, it was demonstrated that 8 weeks after irradiation skin is hypoperfused but normoxic when compared to baseline.

Immunohistochemical analysis was used to validate the hyperspectral findings. It was found that irradiated tissue was hypovascular, consistent with earlier findings. (Marx, et al. 1990 Am J Surg 160: 519-524.) In addition, although it had been previously suggested that pimonidazole detects hypoxic changes in irradiated skin, our study did not demonstrate an increased hypoxic cell fraction. (Westbury, et al. 2007 Br J Radiol 80: 934-938.) Together, these results support the HSI findings of hypoperfused, normoxic cutaneous tissue. To further validate this data, gene expression analysis was performed for the angiogenic factor VEGF and its associated receptors. The finding of downregulation in these target genes, consistent with previous studies, supports the hypothesis of the development and maintenance of a chronic hypovascular state in irradiated skin. (Riedel, et al. 2008 Int J Mol Med 22: 473-480.) The immunohistochemical and gene expression analysis suggest that this hypovascular state may not be a stimulus for local angiogenesis, which may be due in part to the lack of local hypoxia.

The states of hypoperfusion and normoxia are not contradictory. Fibrotic and irradiated tissues have been demonstrated to have lower metabolic demands than healthy tissue, which may explain that while irradiated cutaneous tissue is hypovascular, it remains normoxic. (Widdison, et al. 1995 Gut 36: 133-136; Zannella, et al. 2011 Radiother Oncol 99: 293-299; Sattler, et al. 2010 Radiother Oncol 94: 102-109; Furuta, et al. 2004 Cancer Lett 212: 105-111; Barjaktarovic, et al. 2011 PLoS One 6: e27811.)

### Example 3

Following animal experimentation, preliminary clinical correlation in human patients was investigated. For the human study, patients undergoing external beam breast conserving radiotherapy (n=5) or post-mastectomy radiation (n=1) were enrolled. Total doses ranged between 42 Gy and 50 Gy. Baseline images were obtained before irradiation for bilateral breasts in each patient (one irradiated side and one control side). Images were subsequently taken before and after each fractionated dose at clinic visits for the first month. Skin reaction assessment was performed concurrently with HSI for both murine and human studies.

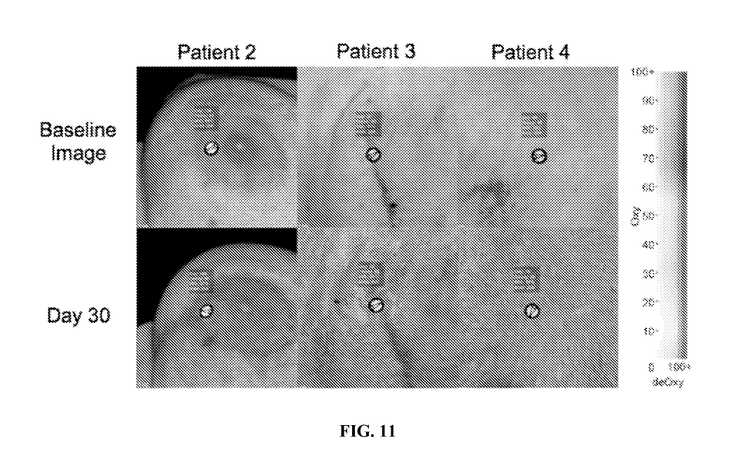

Similar to changes seen in mice, human tissue perfusion in the irradiated breast was found to increase prior to skin reaction formation and continued to steadily increase over the first 30 days in all patients. (See, FIG. 10 and FIG. 11.)

Thus, above patient data suggests that HSI can visualize distinct changes similar to those seen in the murine model.

In this specification and the appended claims, the singular forms “a,” “an,” and “the” include plural reference, unless the context clearly dictates otherwise.

Unless defined otherwise, all technical and scientific terms used herein have the same meaning as commonly understood by one of ordinary skill in the art. Although any methods and materials similar or equivalent to those described herein can also be used in the practice or testing of the present disclosure, the preferred methods and materials are now described. Methods recited herein may be carried out in any order that is logically possible, in addition to a particular order disclosed.

### Incorporation by Reference

References and citations to other documents, such as patents, patent applications, patent publications, journals, books, papers, web contents, have been made in this disclosure. All such documents are hereby incorporated herein by reference in their entirety for all purposes. Any material, or portion thereof, that is said to be incorporated by reference herein, but which conflicts with existing definitions, statements, or other disclosure material explicitly set forth herein is only incorporated to the extent that no conflict arises between that incorporated material and the present disclosure material. In the event of a conflict, the conflict is to be resolved in favor of the present disclosure as the preferred disclosure.

### EQUIVALENTS

The representative examples are intended to help illustrate the invention, and are not intended to, nor should they be construed to, limit the scope of the invention. Indeed, various modifications of the invention and many further embodiments thereof, in addition to those shown and described herein, will become apparent to those skilled in the art from the full contents of this document, including the examples and the references to the scientific and patent literature included herein. The examples contain important additional information, exemplification and guidance that can be adapted to the practice of this invention in its various embodiments and equivalents thereof.

What is claimed is:

1. A method for detecting a subject's exposure to ionizing radiation, comprising:
obtaining photographic imagery of one or more areas of superficial tissue of the subject at one or more wavelengths and one or more time points; and
characterizing the obtained photographic imagery to measure one or more physiological properties in the one or more areas of superficial tissue to detect the level of ionizing radiation exposure of the subject.

2. The method of claim 1, wherein photographic imagery is obtained from one area of superficial tissue of the subject.

3. The method of claim 1, wherein photographic imagery is obtained from two or more areas of superficial tissue of the subject.

4. The method of claim 1, wherein characterizing the obtained photographic imagery to measure one or more physiological properties comprises measuring the level of one or more of oxygenated hemoglobin, de-oxygenated hemoglobin, collagen, lipids, water content, beta-carotene, and melanin.

5. The method of claim 4, wherein characterizing the obtained photographic imagery to measure one or more physiological properties comprises quantifying the level of oxygenated hemoglobin in the imaged area of the subject.

6. The method of claim 4, wherein characterizing the obtained photographic imagery to measure one or more physiological properties comprises quantifying the level of de-oxygenated hemoglobin in the imaged area of the subject.

7. The method of claim 5, wherein an increase or decrease in measured levels of oxygenated hemoglobin in the imaged area of the subject is used as an indication of exposure to ionizing radiation.

8. The method of claim 6, wherein an increase or decrease in measured levels of de-oxygenated hemoglobin in the imaged area of the subject is used as an indication of exposure to ionizing radiation.

9. The method of claim 4, wherein an increase or decrease in measured levels of oxygen saturation in the imaged area of the subject is used as an indication of exposure to ionizing radiation.

10. The method of claim 4, wherein an increase or decrease in measured levels of perfusion in the imaged area of the subject is used as an indication of exposure to ionizing radiation.

11. The method of claim 1, wherein the photographic imagery is obtained at one wavelength.

12. The method of claim 1, wherein the photographic imagery is obtained at two or more wavelengths.

13. The method of claim 1, wherein the one or more wavelengths used to obtain photographic imagery are selected from the range from about 350 nm to about 1,600 nm.

14-18. (canceled)

19. The method of claim 1, wherein characterizing the obtained photographic imagery to measure one or more physiological properties comprises comparing imagery obtained from the specific subject to reference data from a normal population of subjects not exposed to ionizing radiation.

20. A method for determining the time elapse from a prior ionizing radiation exposure of a subject, comprising:
obtaining photographic imagery of one or more areas of superficial tissue of the subject at one or more wavelengths and one or more time points; and
characterizing the obtained photographic imagery to measure one or more physiological properties in the one or more areas of superficial tissue to determine the time elapsed from a prior ionizing radiation exposure of the subject.

21-22. (canceled)

23. The method of claim 20, wherein characterizing the obtained photographic imagery to measure one or more physiological properties comprises measuring the level of one or more of oxygenated hemoglobin, de-oxygenated hemoglobin, collagen, lipids, water content, beta-carotene, and melanin.

24. The method of claim 23, wherein characterizing the obtained photographic imagery to measure one or more physiological properties comprises quantifying the level of oxygenated hemoglobin in the imaged area of the subject.

25. The method of claim 23, wherein characterizing the obtained photographic imagery to measure one or more physiological properties comprises quantifying the level of de-oxygenated hemoglobin in the imaged area of the subject.

26-37. (canceled)

38. The method of claim 20, wherein characterizing the obtained photographic imagery to measure one or more physiological properties comprises comparing imagery obtained from the specific subject to reference data from a normal population of subjects not exposed to ionizing radiation.

39. A method for determining the degree of ionizing radiation exposure by a subject, comprising:
obtaining photographic imagery of one or more areas of superficial tissue of the subject at one or more wavelengths and one or more time points; and
characterizing the obtained photographic imagery to measure one or more physiological properties in the one or more areas of superficial tissue to determining the degree of ionizing radiation exposure of the subject.

40. The method of claim 39, wherein photographic imagery is obtained from one area of superficial tissue of the subject.

41. The method of claim 39, wherein photographic imagery is obtained from two or more areas of superficial tissue of the subject.

42. The method of claim 39, wherein characterizing the obtained photographic imagery to measure one or more physiological properties comprises measuring the level of one or more of oxygenated hemoglobin, de-oxygenated hemoglobin, collagen, lipids, water content, beta-carotene, and melanin.

43-56. (canceled)

57. The method of claim 39, wherein characterizing the obtained photographic imagery to measure one or more physiological properties comprises comparing imagery obtained from the specific subject to reference data from a normal population of subjects not exposed to ionizing radiation.

58-73. (canceled)
